(19) United States
(12) Patent Application Publication
(10) Pub. No.: US 2010/0306574 A1
(43) Pub. Date: Dec. 2, 2010

(54) COMMUNICATION METHOD, COMMUNICATION SYSTEM, NODE, AND PROGRAM

(76) Inventors: Takaaki Suzuki, Tokyo (JP); Tomohiko Yagyu, Tokyo (JP); Kazuya Suzuki, Tokyo (JP)

Correspondence Address: Mr. Jackson Chen, 6535 N. STATE HWY 161, IRVING, TX, 75039, US

(21) Appl. No.: 12/744,719

(22) PCT Filed: Nov. 26, 2008
(86) PCT No.: PCT/JP2008/071412

§ 371 Date: May 26, 2010

(30) Foreign Application Priority Data
Nov. 27, 2007 (JP) 2007-305835

(51) Int. Cl. G06F 11/00

(52) U.S. Cl. 714/4; 714/E11.011

(57) ABSTRACT

The processing load of a path control message on a node due to a link fault is reduced, a normal routing operation is assured, and the stable continuity of a network is realized. The node having received the path control message transmits the path control message to the adjacent node having transmitted the path control message and at least one or more adjacent nodes on an alternate path.

### APPLICABLE FIELD IN THE INDUSTRY

The present invention relates to a communication method, a communication system, a node, and a program, and more particularly to a technology of, at the moment that a fault between neighboring nodes (a link cutting, a node failure, a maintenance, or the like, and hereinafter, it is referred to as a link fault) occurs in a node (AS, a router, etc.), locally updating route information without globally updating it, and preparing an alternate route.

### BACKGROUND ART

Currently, route control protocols for use in internet is divided into IGPs (Interior Gateway Protocols) for taking a route control inside an autonomous system (AS) and EGPs (Exterior Gateway Protocols) for taking a route control between ASs. Herein, the so-called AS is a network that is operated with a single management policy, and, for example, networks such as an in-house network and an ISP (Internet Service Provider) come under this category. That is, generally speaking, the current network backbone is configured of the network within the AS that that is operated with a single management policy, and an inter-AS network that the above AS partners form.

Currently, BGP is disclosed in Non-patent documents 1 and 2 as the EGP that is mainly used in the internet. The BGP, which is a path vector type route control protocol, exchanges route control information (a network address, an AS number, an AS path attribution, etc.) associated with each AS between the ASs. An update message is employed as a message of the route control information in the BGP.

A packet format of the update message is shown in FIG. 1. In FIG. 1, 61, which is expressed by two octets (two bytes) is an unusable route length, and is indicative of a length of a cancel route 62 that is a variable length. The cancel route of 62 becomes a variable length because an address prefix of the network in an destination at which its own AS cannot reach enter it, and yet a plurality of the prefixes can be incorporated into one update message. A path attribute overall-length of 63, which is expressed by two octets, is indicative of a length of a path attribution of 64 that is a variable length. The path attribution of 64 becomes a variable length because at least an ORIGIN attribute, an AS path attribution, and attribution information of a NEXT HOP address enter it, and yet the number of pieces of the attribution information may differ update message by update message. Network arrivability information of 65 becomes a variable length because an address prefix of the network at which its own AS can reach enter it, and yet a plurality of the prefixes can be incorporated into one update message.

Further, there exists a cancel route in the update message, it does not matter that the path attribute or the network arrivability information does not exist, and the above update message is also called a withdraw message. From now on, in the path vector type route control technique that is typified by the BGP, the message having the arrivable route information is called an update message, the message having the cancel route information is called a withdraw message, and both message are collectively called a route control message.

In the path vector type route control protocol that is typified by the BGP, each AS learns the routes to other ASs over the network from the route control message, determines the AS of the next hop corresponding to the destination address of the packet at the moment of transferring the packet, and transfers the packet to the AS of the next hop, thereby to deliver the packet from a transmission source up to the destination. Further, in the BGP, basically, the route (minimum AS path length) of which the number of the hops becomes minimum is preferredly employed, and the route is selected according to the other various policies that are incidental. Herein, the so-called policy in the AS means whether or not a connection to the neighboring AS is permitted, which AS is used preferredly to make a connection, or the like.

Herein, it is a BGP router that actually exchanges the route control information by using the BGP. The AS, which is a network that is operated with a single management policy, is configured of various routers, end user terminals, etc. It is the BGP router, out of the routers constituting the AS, that make communication between the AS partners according to the BGP, and the route control between the ASs is performed by the control BGP router. From now on, so long as the router is not particularly referred to as an AS, the AS is regarded as an equivalent of one BGP router for simplifying the explanation, and is handled.

Specifically, an operation of the packet transfer in the path vector type control protocol will be explained by employing FIG. 2. In this example, for simplifying the explanation, the destination network address is replaced with the AS number. FIG. 2 shows one example of an inter-AS network topology (BGP network topology) in which the route information of each AS has been exchanged by using the update message, and a circle in the figure and a line between the ASs signify the AS and the connection between the AS partners, respectively.

Further, a numerical figure in the circle signifies the AS number, and is a unique value in the network. The AS number is a globally unique number also in the actual internet. Each of squares 21-26 belonging to the AS, which is a node route table, represents information of the AS routes to AS-5 in FIG. 2. In the squares 21-25 of FIG. 2, the upper stage represents all routes to AS-5 that each AS holds, and the lower stage represents a packet transfer destination (Next Hop) in a main route destined for AS-5 (herein, the route of which the number of the hops is minimum). Further, what lies ahead of AS-4 and AS-7 is referred to as internet 71 for short.

It is assumed that the packet addressed to AS-5 has arrived at AS-3. At this time, AS-3 transfers the packet addressed to AS-5 to AS-6 because the transfer destination of the packet addressed to AS-5 is AS-6. AS-6 having received the packet learns from the node route table that the transfer destination of the packet addressed to AS-5 is AS-5, and transfers the packet to AS-5. When AS-5 receives the packet, it learns that AS-5 itself is the destination of the packet, and accepts the packet. As mentioned above, deciding the main route from the route information, obtaining the transmission destination from the main route, and employing it as routing information makes it possible to transfer the packet up to the destination.

In the path vector type control protocol for managing the route information by employing the path attribution information (the path length etc.) and transferring the packet in such a manner, an exchange of the route control information is performed in order to learn the routes to the other nodes within the network as described above. Currently, the internet repeats a scheme that the route control message of the BGP is transmitted to the ASs neighboring each AS according to the policy of the AS, and each of the above neighboring ASs also transmits the route control message to the ASs neighboring each of the above neighboring ASs according to its own policy, thereby allowing the route control message to prevail in an entirety of the network. From now on, this prevalence of the route control message is expressed as being globally notified.

By the way, currently, the internet has a problem that the route information is augmented. Particularly, the inter-AS network has a problem that an increase in the route information occurs due to multi-forming, traffic engineering, etc. Further, participation of a new AS in the network, or the like causes a change to the topology to occur in the BGP network, and the route information to be renewed, whereby the route information is frequently updated so as to maintain new route information at any time, which arouses a problem that the network becomes unstable.

Herein, the so-called multi-forming is a technique in which a certain AS makes a connection to a plurality of the ASs, and lets the route control messages having an identical prefix to flow hereto, thereby to prepare the routes for the prefix in a plural number, and to realize an enhancement in distribution of traffics, fault durability, and so on. Further, the so-called traffic engineering is a technique in which a certain AS makes a connection to a plurality of the ASs, and lets a plurality of the prefixes obtained by sub-dividing one prefix to flow hereto, thereby to realize an enhancement in distribution of the traffics, security, and so on. This technique is utilized for various multi-media, and use of the multi-forming and the traffic engineering is increased recently in the current internet demanding the security and the high-speediness, which incurs hypertrophy of a route information database of the router, an augment in the number of the route control messages that are exchanged, and so on.

As one of causes why the route information is frequently updated, a change to the route information at the time of the link fault can be listed. In the current BGP network, the AS, which has detected the fault of the link to the neighboring AS, globally notifies the effect that the route including the link in which the fault has occurred is unusable by using the withdraw message.

The AS, which has received the withdraw message, deletes the route information for the prefix of the cancel route within the withdraw message. Further, when the link fault is recovered, the above AS globally notifies the update message in order to notify information of arrivability brought about by the recovery (the path attribution and the network arrivability information). The AS, which has received the update message, adds the route information for the prefix of network arrivability information. The link fault temporally occurs in many cases, and when the link fault frequently occurs, the route control message is augmented, the processing load of the route control message upon each AS is increased, besides them, the route information of each AS does not converge, and the network becomes unstable. In the network in which the route information is not stabilized, there is also a risk that the packet does not correctly arrive at the destination due to occurrence of a loop phenomenon and so on.

Herein, detection of the link fault is investigated by using a keep alive message etc. in the BGP. The BGP router connecting the ASs periodically exchanges the keep alive message with the BGP router of the neighboring AS, and both mutually confirm the connection. When the keep alive messages are not exchanged by a portion of specified number of times within a limit time, the BGP router determines that the above connection has the link fault. Further, there exists BFD (Bi-directional Forwarding Detection) etc. besides it as a method of detecting the link fault.

By the way, the various techniques of forming or selecting the alternate route (detour), and forwarding the packet have been proposed as a technique that corresponds to the occurrence of the link fault in the communication network. For example, in JP-P 1994-318953A being Patent document 1, each node pre-holds the main route and the alternate route to each destination node, and makes a switchover of the route for use to the alternate route at the time of occurrence of the fault. In addition, when even the alternate route is unusable due to the link fault, each node transmits a detour impossibility notification packet in an incoming path direction of the packet in its own node, and secures the alternate route to destination of the packet. Herein, the so-called incoming path is a path in a direction, in which the packet has been transferred to (the packet has entered) its own node, for the destination node of the packet, and the path in a direction in which its own node transfers the packet (the packet goes out) becomes an outgoing path. In the technique in which the alternate route is formed or selected, transmitting the control packet only to a specific node, and locally employing the alternate route in such a manner makes it possible to secure the packet communication.

However, in JP-P1994-318953A, an interruption and a loop of the communication still occurs in the multi-fault because the alternate routes to each destination node are pre-established, and are not dynamically changed. Further, while the incoming path of the packet needs to be stored, the storage of the incoming path is difficult from a viewpoint of the load because a large number of the packets are transferred at a high speed in the backbone network of the internet or the like. In addition, in the network in which the packet communication is made between several hundred million terminals as is the case with the internet, transmitting the route control messages in the directions of the incoming paths of all of the packets results in incurring a situation similar to the situation in which the route control messages are transmitted to the entirety of the network, and causes an enormous control loads to occur. For this, the method disclosed in the Patent document 1 is not applicable to the internet.

Non-patent document 1: “Border Gateway Protocol 4 (BGP-4)” IETF RFC 1771 (March, 1995)

Non-patent document 2: “Border Gateway Protocol 4 (BGP-4)” IETF RFC4271 (January, 2000)

Patent document 1: JP-P1994-318953A

### DISCLOSURE OF THE INVENTION

### Problems to be Solved by the Invention

A problematic point in the related arts as described before is that the route control messages are augmented, the load is placed upon the router of the AS, and besides, the route information is not stabilized. When the route information is not stabilized, it is also thinkable that the packet does not arrive at the destination, and the packet loss is triggered because the routing is not properly activated.

One of the reasons why the route control messages are augmented and the route information is not stabilized is put down to the method of controlling the route at the time of the link fault. Many link faults occur temporally. However, the related arts globally notify the route control messages whenever the fault occurs and are recovered notwithstanding the temporal link fault. For this, the route information of each AS is frequently changed, the load is placed upon the router of each AS, and besides, the route information becomes unstable.

Thereupon, the present invention has been accomplished in consideration of the above-mentioned problems, and an object thereof is to reduce the processing load of the route control message upon the node due to occurrence of the link fault, to secure a normal routing operation, and to keep the stable continuity of the network.

### Means to Solve the Problem

The present invention for solving the above-mentioned problem is characterized in that a communication method, wherein a node having received a route control message transmits the route control message to a neighboring node having transmitted said route control message, and at least one neighboring node or more on an alternate route.

The present invention for solving the above-mentioned problem is characterized in that a communication system that is configure of at least one node or more, wherein said node comprises: a storage unit for storing alternate routes; and a route control message transmission unit for receiving a route control message, selecting at least one alternate route or more from among the alternate routes stored in said storage unit, and transmitting the route control message to the neighboring nodes on the selected alternate route, and the neighboring node having transmitted said route control message.

The present invention for solving the above-mentioned problem is characterized in that a node, comprising: a storage unit for storing alternate routes; and a route control message transmission unit for receiving a route control message, selecting at least one alternate route or more from among the alternate routes stored in said storage unit, and transmitting the route control message to neighboring nodes on the selected alternate route, and the neighboring node having transmitted said route control message.

The present invention for solving the above-mentioned problem is characterized in that a program for causing an information processing apparatus to execute: an alternate route selection process of, when receiving a route control message, selecting at least one alternate route or more from among alternate routes stored in a storage unit; and a route control message transmission process of transmitting the route control message to neighboring nodes on the selected alternate route, and the neighboring node having transmitted said route control message.

The present invention for solving the above-mentioned problem is characterized in that a communication method, wherein a node having received a route control message transmits the route control message to neighboring nodes on at least one alternate route or more.

The present invention for solving the above-mentioned problem is characterized in that a node, comprising: a storage unit for storing alternate routes; and a route control message transmission unit for, when receiving a route control message, selecting at least one alternate route or more from among the alternate routes stored in said storage unit, and transmitting the route control message to neighboring nodes on the selected alternate route.

The present invention for solving the above-mentioned problem is characterized in that a communication method, wherein a node having received a cancel route information transmits arrivable route information only to a neighboring node having transmitted the cancel route information.

The present invention for solving the above-mentioned problem is characterized in that a node, comprising a means for, when receiving a cancel route information, transmitting arrivable route information only to a neighboring node having transmitted the cancel route information.

### AN ADVANTAGEOUS EFFECT OF THE INVENTION

In accordance with the present invention, a reduction in the route control messages, which are notified whenever the route to the node lying ahead of the link fault is changed, is realized at the time of occurrence of the fault of the link, or the recovery thereof, and the load of transmitting/receiving the route control message upon the nodes constituting the network is reduced.

### BRIEF DESCRIPTION OF THE DRAWINGS

FIG. 1 is a format of the route control message (the update message of the BGP).

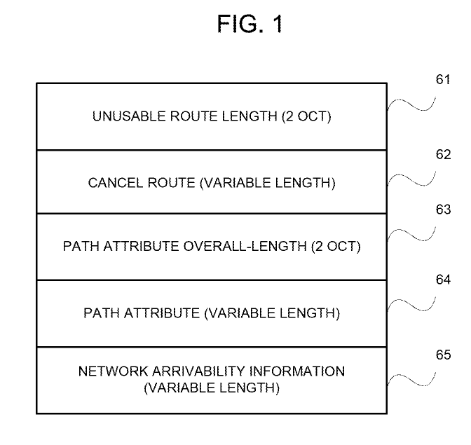

FIG. 2 shows an example of the network topology in the path vector type route control technique.

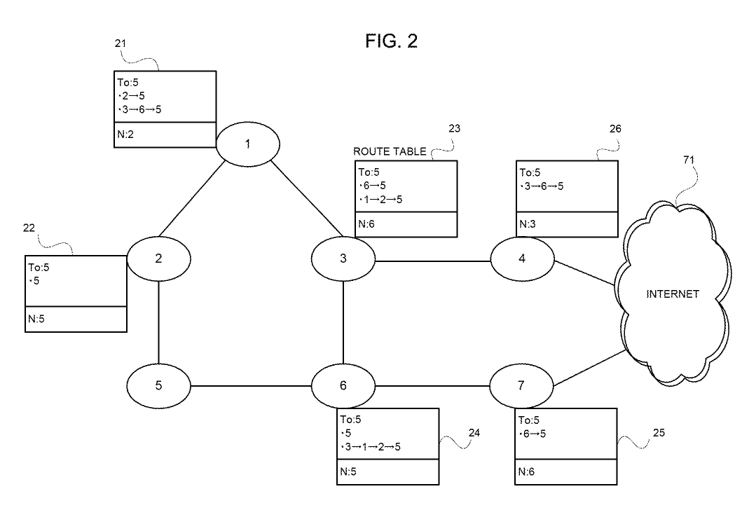

FIG. 3 is a block configuration illustrating one example of a functional configuration of the router apparatus in accordance with the present invention.

FIG. 4 is a flowchart in which the link fault detection node in accordance with the present invention controls the route control message at the time of occurrence of the link fault.

FIG. 5 is a flowchart in which the link fault detection node in accordance with the present invention controls the route control message at the time of recovery of the link fault.

FIG. 6 is a flowchart in which the withdraw message reception node in accordance with the present invention controls the route control message at the time of occurrence of the link fault.

FIG. 7 is a flowchart in which the withdraw message reception node in accordance with the present invention controls the route control message at the time of recovery of the link fault.

FIG. 8 shows an example of the network topology indicative of a transmission situation of the route control message and the route information in accordance with the related technique of the present invention at the time of occurrence of the link fault.

FIG. 9 is route tables of the route control messages in a node 6 before fault occurrence and in a node 6 after fault occurrence in accordance with the related technique of the present invention at the time of occurrence of the link fault.

FIG. 10 shows an example of the network topology indicative of a transmission situation of the route control message and the route information in accordance with the present invention at the time of occurrence of the link fault.

FIG. 11 is route tables in the node 6 before the fault occurrence and in the node 6 after the fault occurrence in accordance with the present invention at the time of occurrence of the link fault.

FIG. 12 shows an example of the network topology indicative of a transmission situation of the route control message and the route information in accordance with the present invention at the time of occurrence of a plurality of the link faults.

FIG. 13 is a block configuration illustrating another example of the functional configuration of the router apparatus in accordance with the present invention.

FIG. 14 is a flowchart in which the link fault detection node in accordance with the present invention controls the route control message, which takes determination of kinds of the faults by a fault time into consideration.

FIG. 15 is a flowchart in which the route control message reception node in accordance with the present invention controls the route control message, which takes determination of kinds of the faults by a fault time into consideration.

FIG. 16 shows an example of the network topology indicative of a transmission situation of the route control message and the route information in the case of employing a plurality of the alternate routes in accordance with the present invention at the time of occurrence of the link fault.

### DESCRIPTION OF NUMERALS

1A and 1B router apparatuses
11 route controller
111 topology exchanger
112 policy manager
113 main route calculation unit
114 alternate route calculation unit
12 packet transfer unit
121 routing policy manager
122 routing processing unit
123 use route table
13A and 131 fault detectors
13B fault recognizer
132 fault kind determiner
14A update message transmission controller
14B update message controller
141 transmission kind determiner
142 transmission controller
15 route table (RIB)
16 network interface
20 to 27 node route tables
31 and 32 link faults
41 to 49 route control messages (update message or withdraw message)
51 and 52 data packets
61 unusable route length
62 cancel route
63 path attribution overall-length
64 path attribution
65 network arrivability information
71 internet

### BEST MODE FOR CARRYING OUT THE INVENTION

### First Embodiment

Next, the first embodiment of the present invention will be explained in details by making a reference to the accompanied drawings. The characteristic of the first embodiment lies in a point of transmitting the route control message not to all of the neighboring nodes but to the limited neighboring nodes. In particular, the first embodiment is mainly characterized in transmitting the route control message to the nodes existing along the alternate routes. This yields an effect that the route control message is reduced.

In addition, the first embodiment of the present invention is characterized in stopping transmission of the route control message at the node that exists halfway along the alternate route. This enables an effect that the route control messages are reduced all the more to be derived.

While these two characteristics will be explained in the first embodiment, the largest characteristic of the first embodiment lies in a point of transmitting the route control message not to all of the neighboring nodes but to the limited neighboring nodes.

Further, while not only an operation at the time of the link fault, but also an operation at the time of the link recovery will be explained in the first embodiment, the furthermore effect can be derived in the operation at the time of the link recovery.

Additionally, from now on, the message having the arrivable route information is explained as an update message, the message having the cancel route information as a withdraw message, and both message as a route control message collectively.

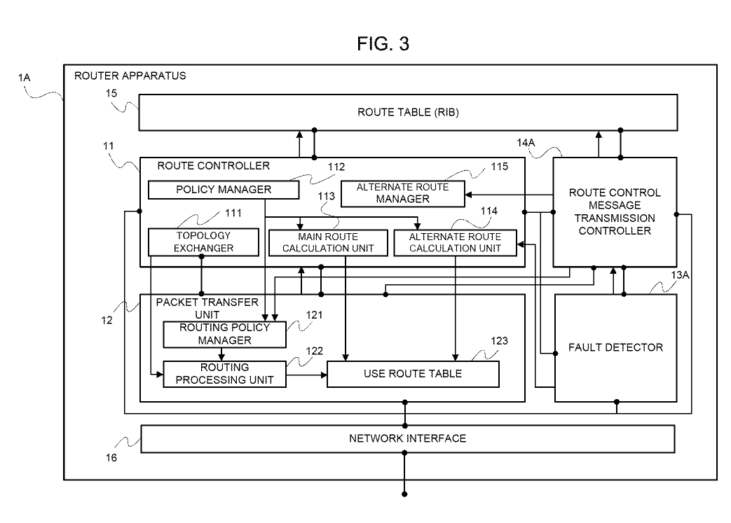

FIG. 3 is a block configuration illustrating one example of a functional configuration of a router apparatus 1A in accordance with the present invention. In FIG. 3, elements having a relation with each other, out of configuration elements, are connected with a straight line, and are displayed. Information is directly exchanged between the elements connected with a straight line. Further, a directed line, which is used for explaining the characteristics of the present invention, signifies the detailed control and reference of each configuration element.

In FIG. 3, the router apparatus 1A in accordance with present invention includes and is configured of at least a route controller 11, a packet transfer unit 12, a fault detector 13A, a route control message transmission controller 14A, a route table (RIB) 15, and a network interface 16.

The route controller 11 includes and is configured of a topology information exchanger 111, a policy manager 112, a main route calculation unit 113, an alternate route calculation unit 114, and an alternate route manager 115. The packet transfer unit 12 includes and is configured of a routing policy manager 121, a routing processing unit 122, and a use route table 123. The fault detector 13A detects the fault, and the route control message transmission controller 14A takes a control associated with transmission of the route control message. The route table (RIB) 15 keeps information of all of the routes to each destination acquired and changed with the route control message. The network interface 16 is responsible for a connection to each neighboring router apparatus, and transmits/receives the packet to/from the neighboring router.

In the route controller 11, the topology information exchanger 111 exchanges the route information with the neighboring router apparatus by using the path vector type route control protocol relating to the present invention, for example, the BGP. The topology information exchanger 111 gives an instruction for transmitting the route information to the routing processing unit 122. An exchange of the route information is performed with the route control message, the arrivable route information is contained in the update message, and the cancel route information is contained in the withdraw message. The collected route information is recorded in the route table (RIB) 15, and is kept. The policy manager 112 manages the policy as to which route, out of the collected routes, is employed as a main route or an alternate route, the policy as to the method of selecting the route that is kept in the route table (RIB) 15, out of the routes contained in the obtained route information, or the like.

Further, the policy manager 112 gives the information that becomes a basis of the policy of transmitting the packet, and the policy of searching the use route table 123 in the routing policy manager 121 of the packet transfer unit 12. The main route calculation unit 113 obtains the main route up to each destination according to the policy decided by the policy manager 112. The transmission destination information (Next Hop information) in the obtained main route is registered in the use route table 123 of the packet transfer unit 12. The alternate route calculation unit 114 calculates the alternate route up to the destination to which a connection through the main route becomes impossible due to the link fault according to the policy decided by the policy manager 112 when the link fault has been recognized by the fault detector 13A. The information of the transmission destination in the calculated alternate route is registered in the use route table 123 of the packet transfer unit 12. The alternate route manager 115 manages the destination lying ahead of the link fault, the information of the alternate route to the above destination, and the information as to whether or not the transfer of the route control message has been stopped.

In the packet transfer unit 12, the routing policy manager 121 manages the policy associated with the routing based upon the information received from the policy manager 112 of the route controller 11, and the route control message transmission controller 14A. The routing policy manager 121 gives a rule to the process of the routing processing unit 122 responding to a necessity. The routing processing unit 122 makes a reference to a destination field existing in the header part of the packet received from the network interface 16, retrieves the next transfer destination address by employing the use route table 123 when the destination is not destined for itself, and sends out the received packet to the router apparatus having the next transfer destination address. The routing processing unit 122 does not transfer the received packet when the destination is destined for itself. The use route table 123 keeps the currently-used active route information (transmission destination information) for each destination address. Herein, it does not matter that the use route table 123 keeps a plurality of pieces of the active route information for one destination. The routing policy manager 121 uses and manages a plurality of pieces of the active route information via the routing processing unit 122.

The fault detector 13A detects the link fault through the network interface 16. The detected information is conveyed to the alternate route calculation unit 114 and the route control message transmission controller 14A. As a method of detecting the link fault in the fault detector 13A, the foregoing keep alive message and BFD, or the like can be employed.

The route control message transmission controller 14A receives the route control message received by the network interface 16. The route control message transmission controller 14A performs the following process when receiving the withdraw message at the time of occurrence of the link fault.

1. In the route table (RIB) 15, it raises a flag saying that the route to each destination, which is contained in the withdraw message to the transmission partner of the withdraw message, is unusable.

2. In the route to each destination to which a connection through the main route has been cut due to the link fault, it compares the main route (referred to as a fault route) obtained by the main route calculation unit 113, which includes the fault link, with the alternate route obtained by the alternate route calculation unit 114 by employing an evaluation function.

3. It defines F( ) as an evaluation function. It instructs the routing policy manager 121 to transmit the withdraw message only to the transfer destination of the use route obtained by the alternate route calculation unit 114, and further, to transmit the update message only to the transfer destination of the fault route when F(fault route)>F(alternate route). When F(fault route)≦(alternate route), the route control message transmission controller 14A stops the transfer of the withdraw message, and stores the destination lying ahead of the link fault, the information of the alternate route to the above destination, and the fact that the transfer has been stopped in the alternate route manager 115 of the route controller 11.

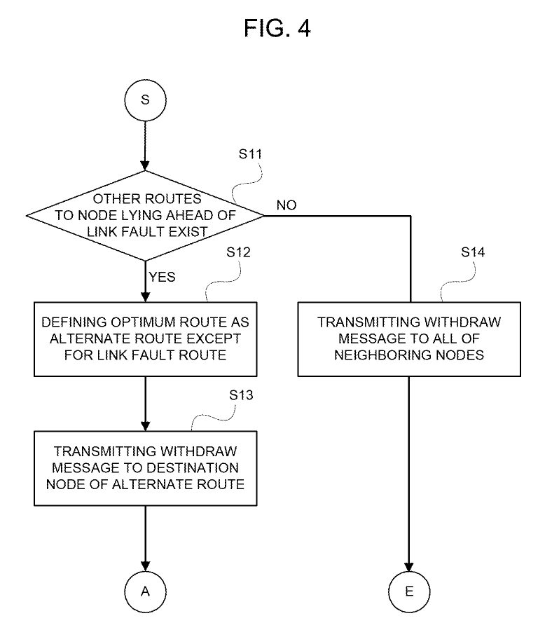

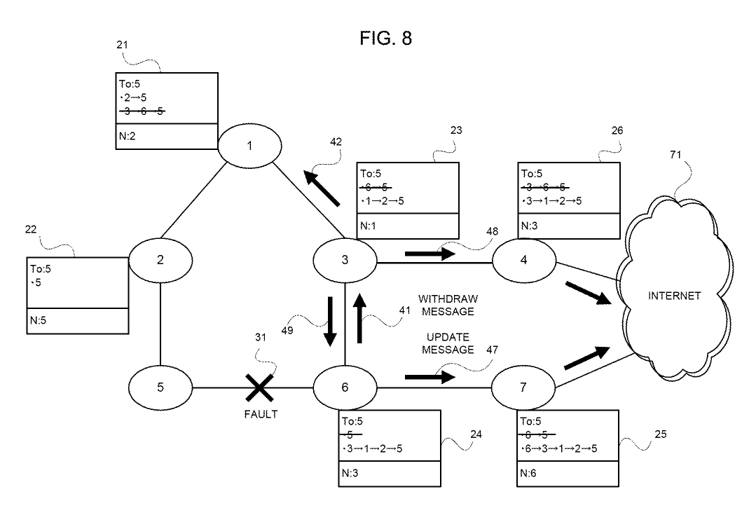

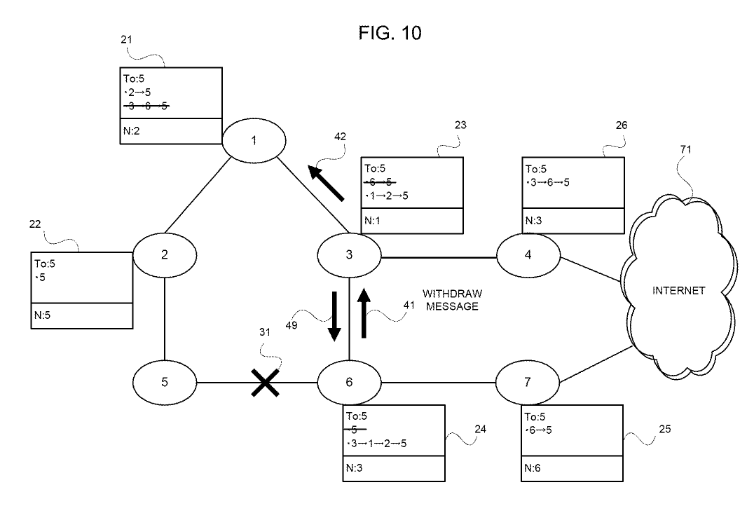

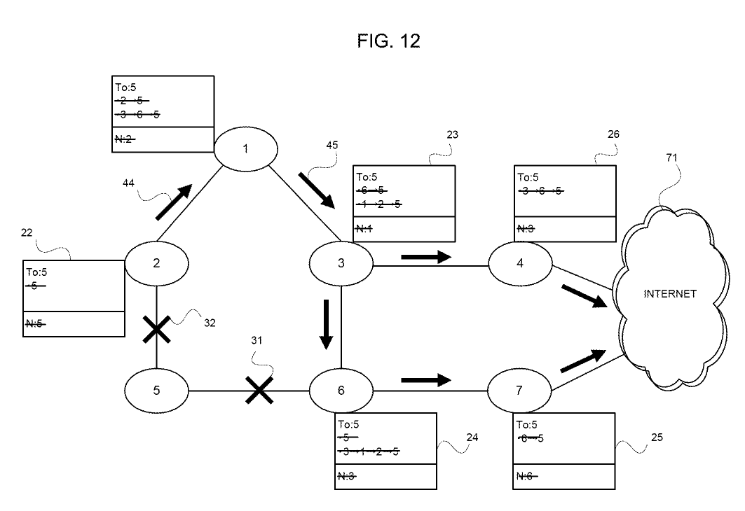

Next, an operation of the router apparatus 1A in accordance with the present invention, and a change in the situation of the network are shown by making a reference to FIG. 4 to FIG. 12. Each of FIG. 4 to FIG. 7 is a flowchart illustrating one example of the process at the time of occurrence of the link fault and at the time of the recovery in the router apparatus 1A in accordance with the present invention. Each of FIG. 8, FIG. 10, and FIG. 12 shows a situation of the network at the time of occurrence of the link fault. In FIG. 8, FIG. 10, and FIG. 12, a circle is a node, which is configured of one router apparatus or a plurality of the router apparatuses like the case of the AS. Herein, it is assumed that the operation of the node is similar to the operation of one router apparatus.

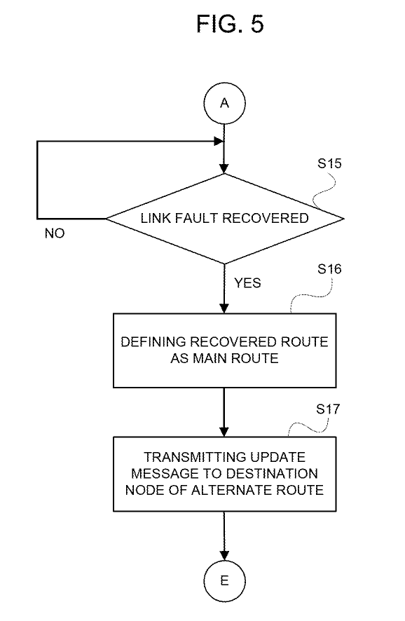

Each of FIG. 4 and FIG. 5 is a flowchart for explaining the operation of the router apparatus 1A that has detected the link fault in the fault detector 13A in accordance with the present invention. The operation at the normal time is similar to that of the router apparatus relating to the present invention. Further, the router apparatus having detected the link fault does not need to send the update message to the route control message transmission source because only a possibility that the router apparatus itself is a transmission source of the route control message exists. FIG. 4 shows the operation that is performed until the route control message is transmitted, and FIG. 5 shows the operation associated with the wait after transmitting the route control message and the recovery.

At first, the operation of FIG. 4 will be explained.

In the router apparatus 1A having detected the link fault, the route controller 11 makes a reference to the route table (RIB) 15, and investigates whether the other routes to the node lying ahead of the link fault exist. The router apparatus 1A proceeds to a step S12 when it exists, and proceeds to a step S14 when it does not exist (step S11).

The alternate route calculation unit 114 obtains the optimum alternate route, out of all of the routes to the node lying ahead of the link fault, except for the route including the link fault (hereinafter, referred to as a link fault route) according to the policy of the policy manager 112, and registers the destination of the node lying ahead of the link fault to which the packet is transmitted in the use route table 123 (step S12).

The route control message transmission controller 14A transmits the withdraw message notifying the effect that the arrival to the destination has become impossible due to the link fault to the destination of the packet transmission of the use route table obtained in the step S12 (step S13).

The route control message transmission controller 14A transmits the route control message to all of the neighboring nodes according to the route table updated due to the link fault in order to globally notify the route control message to the entirety of the network when the other routes to the node lying ahead of the link fault do not exist, and thereafter, returns to the operation at the normal time (step S14).

Next, the operation of FIG. 5 will be explained. This operation is associated with the recovery, and starts at a situation of A of FIG. 4 because it takes over the operation at the time of the fault.

The router apparatus 1A is in a wait mode for the destination due to the above link fault, and waits for the recovery of the link fault (step S15).

The router apparatus 1A having detected the recovery of the link fault in the fault detector 13A defines the recovered route as an optimum route in the main route calculation unit 113, and registers the packet transmission destination in the use route table 123 (step S16).

The route control message transmission controller 14A transmits the update message notifying the effect that the arrival to the destination has become possible owing to the link recovery to the packet transmission destination of the alternate route employed at the time of the link fault, and thereafter, returns to the operation at the normal time (step S17).

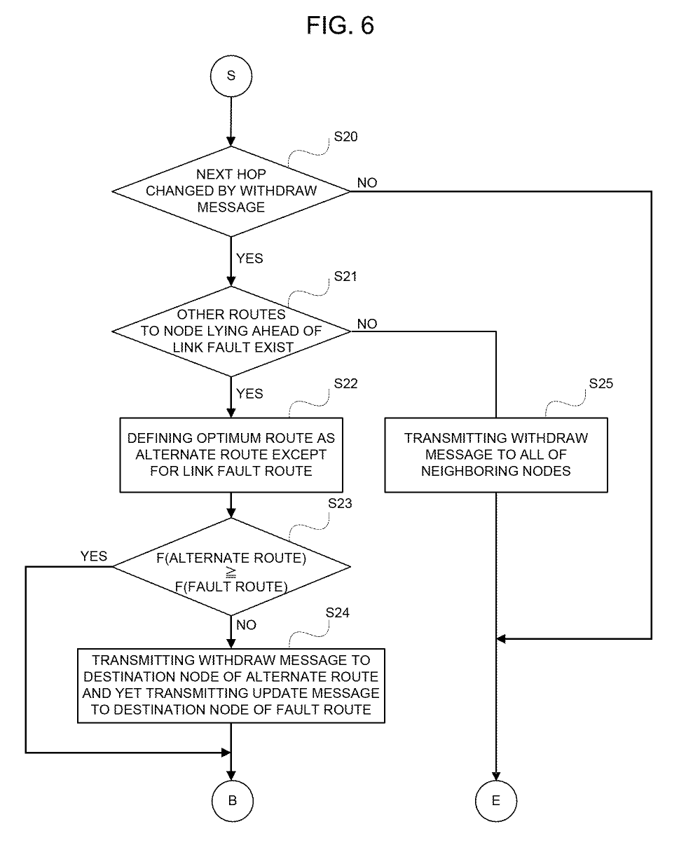

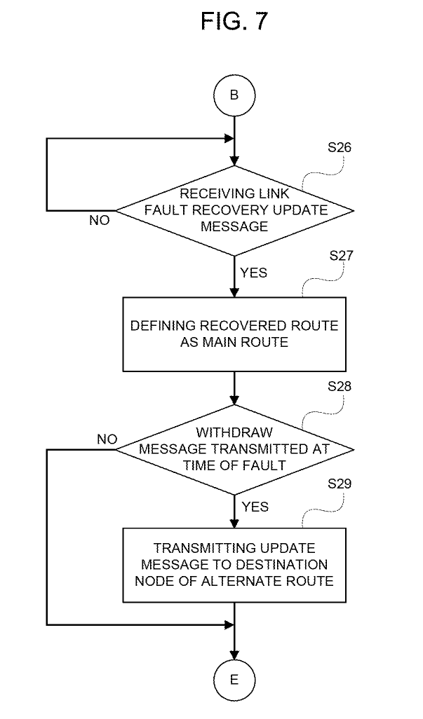

Next, an operation of the router apparatus 1A having received the route control message in accordance with the present invention will be explained by employing FIG. 6 and FIG. 7. Herein, the so-called route control message in accordance with the present invention is the withdraw message transmitted in the step S13 shown in FIG. 4, which is locally transmitted along the alternate route. FIG. 6 shows the operation that is performed until the route control message is transmitted, and FIG. 7 shows the operation associated with the wait after transmitting the route control message and the recovery.

At first, the operation of FIG. 6 will be explained.

The router apparatus 1A having received the withdraw message proceeds to a step S21 when the Next Hop information, which is kept in the use route table 123, differs from the Next Hop information that is obtained before receiving the withdraw message as a result of a series of the route information processes, and otherwise, proceeds to the operation at the normal time without performing anything (step S20).

The router controller 11 makes a reference to the route table (RIB) 15, and investigates other routes to node lying ahead of the link fault exist. The router controller 11 proceeds to a step S22 when it exists, and proceeds to a step S25 when it does not exist (step S21).

The alternate route calculation unit 114 obtains the optimum alternate route, out of all of the routes to the node lying ahead of the link fault, except for the link fault route according to the policy of the policy manager 112, and registers the destination of the node lying ahead of the link fault to which the packet is transmitted in the use route table 123 (step S22).

The route control message transmission controller 14A compares the route (fault route in the figure) defined as a main route before occurrence of the fault, out of the link fault routes, with the alternate route obtained in the step S22 by employing an evaluation function F( ). The route control message transmission controller 14A proceeds to a step S24 unless F(alternate route)<F(fault route), and stops the transmission of the withdraw message when F(alternate route)≧F(fault route), stores the fact that the transmission of the withdraw message has been stopped in the alternate route manager 115, and proceeds to B (step S23).

The route control message transmission controller 14A transmits the withdraw message notifying the effect that the arrival to the destination has become impossible due to the link fault to the destination of the packet transmission of the use route table obtained in the step S22. Further, simultaneously therewith, the route control message transmission controller 14A transmits the update message containing the information of the alternate route to the destination of the packet transmission in the link fault route (step S24).

The route control message transmission controller 14A transmits the route control message to all of the neighboring nodes according to the route table updated due to the link fault in order to globally notify the route control message to the entirety of the network when the other routes to the node lying ahead of the link fault do not exist, and thereafter, returns to the operation at the normal time (step S25).

Next, the operation of FIG. 7 will be explained. This operation, which is associated with the recovery, starts at a situation of B of FIG. 6 because it takes over the operation at the time of the fault.

The router apparatus 1A is in a wait mode for the destination due to the above link fault, and waits for the recovery of the link fault (step S26).

The router apparatus 1A having received the update message notifying the effect that the arrival to the destination has become possible owing to the recovery of the link fault defines the recovered route as an optimum route in the main route calculation unit 113, and registers the packet transmission destination in the use route table 123 (step S27).

The route control message transmission controller 14A investigates whether the withdraw message has been transmitted at the time of the fault, proceeds to a step S29 when it has been transmitted, and returns to the operation at the normal time when the transmission has been stopped (step S28).

The route control message transmission controller 14A transmits the update message notifying the link recovery to the node to which the withdraw message was transmitted at the time of the link fault, namely the packet transmission destination of the alternate route, and thereafter, returns the operation at the normal time (step S29).

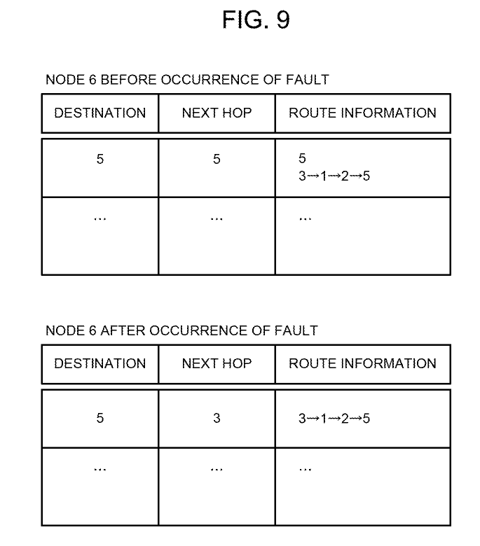

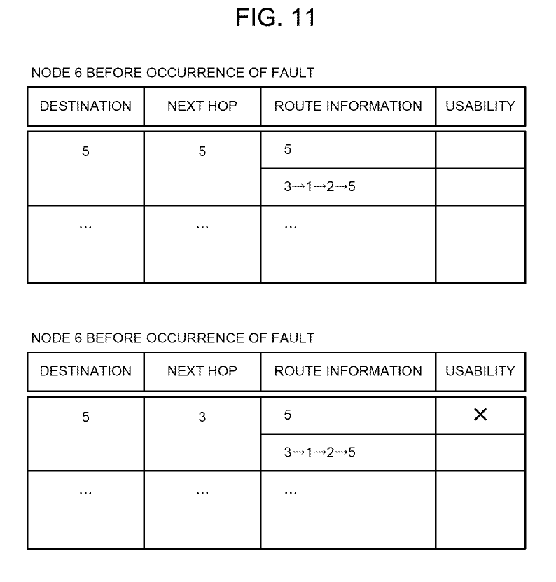

A comparison with the related technique of the present invention is made in the network topology by employing examples of FIG. 8 and FIG. 10, and how the route control message is exchanged according to the suggestion in accordance with the present invention will be explained. Each of squares 21 to 25 in the flank of the node is a node route table, the upper stage of the route table represents information of the route up to node 5 (what is called the route table (RIB) 15 in the router apparatus), and the lower stage represents the information of the transfer destination of the packet addressed to the node 5 (what is called the use route table 123 in the router apparatus). Further, the node on which a traverse line is drawn is a node having the flag of unusability attached hereto, or a deleted node. Further, a difference of the route table between the related technique of the present invention and the suggestion in accordance with the present invention will be explained by employing FIG. 9 and FIG. 11.

FIG. 8 shows the method of transmitting the route control message in accordance with the related technique (BGP) of the present invention.

At first, the operation at the time of the link fault will be explained. A node 6 having detected a link fault 31 deletes the link fault route (in this example, the destination is only a node 5, so only a route entry to the node 5 is deleted), and the node 6 transmits a withdraw message 41 to the nodes of a new main route destined for the node 5. Herein, the node 6 transmits the withdraw message 41 to the node 3 because 3→1→2→5 is a new main route. Further, the node 6 transmits an update message 47 in which the new main route has been incorporated as arrivability information to all of the neighboring nodes except for the node lying ahead of the link fault. Herein, the node 6 transmits the update message 47 to the node 7. That is, the node 6 transmits the route control message to all of the neighboring nodes except for the node lying ahead of the link fault.

The node 3 having received the withdraw message 41 deletes a route (6→5) to the node 6, being an entry of the next destination of the transmission to the node 5, newly selects the main route from among the routes of the node route table, transmits a withdraw message 42 to a node 1, being a transmission destination on the main route, and transmits update messages 48 and 49 into which the newly-selected main route has been incorporated as arrivability information to all of the neighboring nodes other than the node 1 (herein, the node 6 and the node 4), respectively. That is, the node 3 transmits the route control message to all of the neighboring nodes. The node 7 and the node 4 having received the update message 47 and the update message 48, respectively, update the route information even without changing Next Hop destined for the node 5, and globally notifies the update message to the internet 71. In such a manner, the route control message due to the occurrence of the link fault is globally notified, and the route is updated. While the node 1 receives the withdraw message, and deletes a route 3→6→5, it does not transmit the route control message because 2→5 being a before-reception main route, is not influenced at all, and Next Hop is not changed.

FIG. 9 is a route table of the node 6 before occurrence of the link fault and a route table of the node 6 after occurrence of the link fault in the related technique of the present invention of FIG. 8. The destination is indicative of a destination of the packet, Next Hop is indicative of a transmission destination node of the packet for the destination, and the route information is indicative of information of all of the routes to the destination.

Next, the operation at the time of the link recovery will be explained. The node 6 having learned the link recovery defines the route 5 as a main route, and defines it as a usable route. And, the node 6 transmits the update message in which the arrivability information and the AS path attribution have been incorporated to the node 3 and the node 7. The node 3 having received the update message newly adds the route of 6→5 to the route table, defines the main route as 6→5, and defines it as a usable route. And the node 3 transmits the update message to the node 1 and the node 4. The node 7 receives the update message addressed to the destination 5 from the node 6, and overwrites the kept information of the route to the destination 5 (the route has been established as 6→3→1→2→5 at the time of the link fault) received from the identical node 6 with this-time route information (6→5). The node 1, similarly to the node 3, newly adds the route to the route table. Further, the node 4, similarly to the node 7, overwrites the route table. In addition, each of the node 4 and the node 7 globally notifies the update message to the internet 71. The update message is notified globally in such a manner.

FIG. 10 shows the method of transmitting the route control message in accordance with the technique proposed by the present invention.

At first, the operation at the time of the link fault will be explained. The node 6 having detected the link fault 31 raises a flag of unusability in the link fault route, and defines the optimum route, out of all of the routes 24 to the node 5, as an alternate route (herein, 3→1→2→5). Thereafter, the node 6 transmits the withdraw message 41 to the transmission destination node (herein, the node 3) of the alternate route.

The node 3 having received the withdraw message 41 defines the link fault route as unusable due to a change to Next Hop, and defines the optimum route, out of all of routes 23, as an alternate route (herein, 1→2→5). Thereafter, the node 3 compares the alternate route with the main route in which the link fault (hereinafter, referred to as a fault route) has occurred by employing the evaluation function F( ). Herein, while a reciprocal of the route length (a hop length) of the route, a priority degree of the route according to the policy, a stability of the route (a failure rate etc.), a cost of the route (a band, a distance, etc.), and so on are thinkable as an evaluation element of the function, F( ) is defined as a function that returns a reciprocal of the route length for simplicity in the example.

Further, for evaluation, it is also possible to add a margin at least so long as a loop is not generated, and a comparison result of the evaluation function is changed with the margin. Herein, it is assumed that no margin exists, and a comparison result obtained by employing only the evaluation function without adding the margin is observed.

The node 3 transmits a withdraw message 42 to the transfer destination node (herein, the node 1) of the alternate route because F(1→2→5)<F(6→5) in the node 3. Further, the node 3 transmits an update message 49 to the withdraw message transmission source node (herein, the node 6).

The node 1 having received the withdraw message 42 selects the alternate route with an operation similar to the operation of the node 3. Thereafter, the node 1 compares the alternate route with the fault route with the evaluation function F( ). The node 1 stops the transfer of the withdraw message because F(2→5)≧F(3→6→5) in the node 1, and stores the fact that it has been stopped.

FIG. 11 is route table of the node 6 before occurrence of the link fault and the node 6 after occurrence of the link fault according to the technique proposed by the present invention of FIG. 10. In the proposed technique, the item of the flag of unusability is added to the route table. There is no possibility that the route for which the flag of unusability has been raised is selected in the selection of the main route and the selection of the alternate route.

Next, the operation at the time of the link recovery will be explained.

The node 6 having detected the recovery of the link defines the route defined as unusable at the time of the link fault as usable, and defines the main route as a use route. Thereafter, the node 6 transmits the update message to the transfer destination node of the alternate route (herein, the node 3). The node 3 having received the update message learns that the arrivability information of the update message and the AS path attribution (5→6) correspond to the route (5→6) of the route table for which the unusability flag of the route table has been raised, defines the route determined to be unusable at the time of the link fault as a main route, and transfers the update message to the node 1, being a transfer destination node of the alternate route. The node 1 having received the update message recovers the route defined as unusable similarly. Further, the node 1 stops the transfer of the update message because it has stored the fact that the transfer of the withdraw message was stopped at the time of the fault.

FIG. 12 shows the method of transmitting the route control message in the case that the alternate route to the destination has been lost in a plurality of the link faults according to the technique proposed by the present invention. Further, a flowchart on this operation is omitted because it is obtained by simply changing the flowcharts shown in FIG. 4 to FIG. 7.

Firstly, as described in FIG. 10, it is assumed that the link fault has been detected, the withdraw message has been transferred from the node 6 up to the node 1, and the alternate route has been formed. At this time, when it is assumed that a link fault 32 has occurred, the node 2 detects the fault, defines the route including a fault link 2→5 (the link fault route) as unusable, and thereafter, learns that the information of the route to the node 5 has been lost, and deletes the information of the route defined as unusable. And, the node 2 transmits a withdraw message 44 to all of the neighboring nodes similarly to the related technique of the present invention. Herein, the node 2 transmits the withdraw message 44 to the node 1. The node 1 having received the withdraw message 44 defines the link fault route as unusable. Herein, the node 1 recognizes that all of the routes to the node 5 have become unusable, and deletes the route for which the flag of unusability has been raised from the route information. And, the node 1 transmits a withdraw message 45 to all of the neighboring nodes similarly to the related technique of the present invention. The node 3 receives the withdraw message 45, and deletes the route information similarly, and transmits the withdraw message to all of the neighboring nodes. In such a manner, the withdraw message is notified to the entirety of the network, and all of the nodes update (delete) the route information. In this example, any node of FIG. 12 loses the information of the route destined for the node 5 because the other routes destined for the node 5 do not exist; however, when the withdraw message is conveyed to the node that keeps the other routes destined for the node 5, the update message may be transmitted by the above node, and hence, the other routes destined for the node 5 may be gained.

In such a manner, in the above-mentioned example, the withdraw message is transferred not to all of the neighboring nodes, but to the limited neighboring nodes, in particular, to the nodes existing along the alternate route at the time of the link fault and at the time of the link recovery, whereby there is no possibility that the route control message is globally notified as is the case with the related technology of the present invention, the number of the route control messages can be reduced, and besides, the rewrite of the route table, which occurs frequently, can be also reduced.

In addition, in this example, giving an instruction for transmitting the withdraw message to only the nodes existing along the alternate route, and switching the route makes it possible to secure the arrivability of the packets coming from all of the nodes without incurring the loop phenomenon while locally constituting the alternate route.

Moreover, the node existing along the alternate route determines whether or not to transmit the withdraw message by employing the evaluation function, and transmits the withdraw message that is a minimum for securing the arrivability of the packet, whereby the number of the withdraw messages can be reduced all the more.

Further, globally notifying the withdraw message to the entirety of the network when the route up to the destination node has been lost allows the link fault to be notified to the node having the other routes up to the destination that the above node itself does not learn, and the update into the new route information to be globally performed.

Additionally, while the explanation was made by referencing the BGP as the related art (in particular, the method of keeping the route table, the kinds of the route control messages, and the transmission/reception process of the route control messages) in the above-mentioned embodiment, the examples, which also include examples to be described later, are only exemplifications of the present invention, and the present invention is not limited to the BGP, and can be employed for all kinds of the path vector type route control protocols. While the BGP necessitates transmitting the control message to both of the neighboring node having transmitted the route control message, and the neighboring nodes existing on the alternate routes to the route in which the fault has occurred, the present invention is also applicable to the protocol for sending the control message only to one node or a plurality of the nodes, out of the neighboring node having transmitted the message, the neighboring nodes existing on the alternate route, and the neighboring nodes other than these. With the protocol for sending the control message to the neighboring nodes existing on the alternate route, it is also possible to stop the transfer of the message by combining it with the evaluation function similarly to this embodiment.

As mentioned above, in the first embodiment, the node having detected the link fault locally transfers the route control message not to all of the neighboring nodes, but to the limited neighboring nodes, in particular, to the nodes existing along the alternate route at the time of occurrence of the link fault, thereby enabling the number of the route control messages to be reduced. Further, the route control message transfer node existing on the alternate route compares the alternate route with the fault route by employing the evaluation function, and stops the transfer of the route control message when the stoppage condition is satisfied, thereby enabling the number of the route control messages to be reduced all the more.

Further, at the time of the recovery of the link fault, locally transferring the route control message along the alternate route, and yet transferring the route control message up to the node to which the transfer of the route control message has been stopped at the time of occurrence of the fault similarly to the case at the time of the occurrence enables the number of the route control messages to be reduced.

In addition, globally notifying the route control message when the alternate route to the identical destination node cannot be selected makes it possible to make a request for a new alternate route to the other nodes, and globally updating the route information when no alternate route exists makes it possible to realize the stabilization of the network.

### Second Embodiment

The second embodiment of the present invention will be explained.

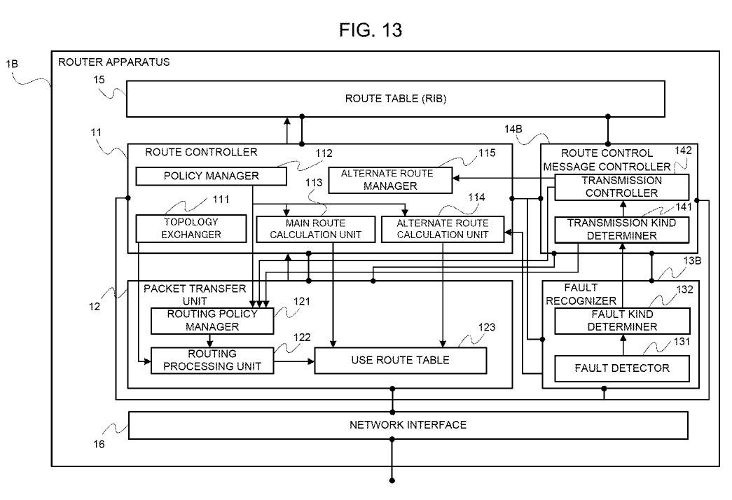

In the second embodiment, while a basic configuration of the router apparatus is one shown in FIG. 3 mentioned above, a furthermore contrivance is performed for the fault detector 13A and the route control message transmission controller 14A. A block configuration of its router apparatus 1B is shown in FIG. 13.

In the router apparatus 1B in this embodiment, a fault recognizer 13B includes and is configured of a fault detector 131, and a fault kind determiner 132. A route control message controller 14B includes and is configured of a transmission kind determiner 141, and a transmission controller 142.

In the fault recognizer 13B, the fault detector 131 detects the link fault via the network interface 16.

The fault kind determiner 132 determines whether the link fault detected by the fault detector 131 is a temporal fault or a permanent fault. The fault kind determiner 132 notifies a result of the determined kind of the faults to the transmission kind determiner 141 of the route control message controller 14B. Herein, as a method of determining the kind of the faults in the fault kind determiner 132, the method of determination by a length of the fault time (the fault is determined as permanent when a time fault equal to or more than a certain threshold continuously occurs), the method of determination by statistics (statistics such as an occurrence frequency and the number of times) of the past occurrence of the faults (the fault is determined as permanent when an occurrence interval or the number of times thereof is equal to or more than a certain threshold), the method of determination by an importance degree of the content of the detected fault (when the content of the faults can be grasped, for example, the fault is a router fault, or the fault is a link cutting, and these faults are level-classified, the fault of which the fault level is a certain level or more is determined as permanent), and so on are thinkable, and the determination method can be arbitrarily determined by a user. For simplicity, it is assumed in this example that a determination as to whether the fault is temporary or permanent is made by a criterion as to whether or not the length of the fault time exceeds a threshold.

In the route control message controller 14B, the transmission kind determiner 141 determines the method of transmitting the route control message based upon the kind of the faults received from the fault kind determiner 132 of the fault recognizer 13B. The transmission kind determiner 141 instructs the transmission controller 142 to transmit the route control message that corresponds to the kind of the fault.

The transmission controller 142 transmits the route control message when an instruction for transmitting the route control message is given by the transmission kind determiner 141.

The transmission kind determiner 141 instructs the transmission controller 142 to perform the transmission of the route control message only for the transmission destination of the use route obtained by the alternate route calculation unit 114 of the route controller 11 when the kind of the fault is a temporal fault. Further, the transmission kind determiner 141 instructs the transmission controller 142 to transmit the route control message to all of the neighboring router apparatuses, and to globally notify the transmission thereof when the kind of the fault is a permanent fault. When the transmission controller 142 receives the route control message received by the network interface 16, it makes a reference to a transmission kind field existing in the packet header part of the route control message. The transmission controller 142 instructs the routing policy manager 121 of the packet transfer unit 12 to transmit the route control message to all of the neighboring router apparatuses so as to perform transmission similar to the transmission of the related technique of the present invention when an instruction for performing the transmission to the entirety of the network has been given to the transmission kind field.

Further, the transmission controller 142 instructs the routing policy manager 121 of the packet transfer unit 12 to transmit the route control message only to the transmission destination of the use route obtained by the alternate route calculation unit 114 of the route controller 11 when an instruction for performing the transmission to the alternate route has been given to the transmission kind field.

Further, the transmission controller 142, similarly to the route control message transmission controller 14A of the example 1, raises the flag saying that the route of which the destination lies ahead of the link fault is unusable when receiving the route control message indicative of the temporal fault, determines whether to transmit the route control message or to stop the transmission thereof by employing the evaluation function F( ) and stores its content in the alternate route manager 115 at the moment of stopping the transmission. Further, when the transmission controller 142 receives the route control message indicative of the permanent fault, and when the link fault time exceeds the threshold that each router apparatus has, the transmission controller 142 deletes the route of which the destination lies ahead of the link fault from the router table (RIB) 15.

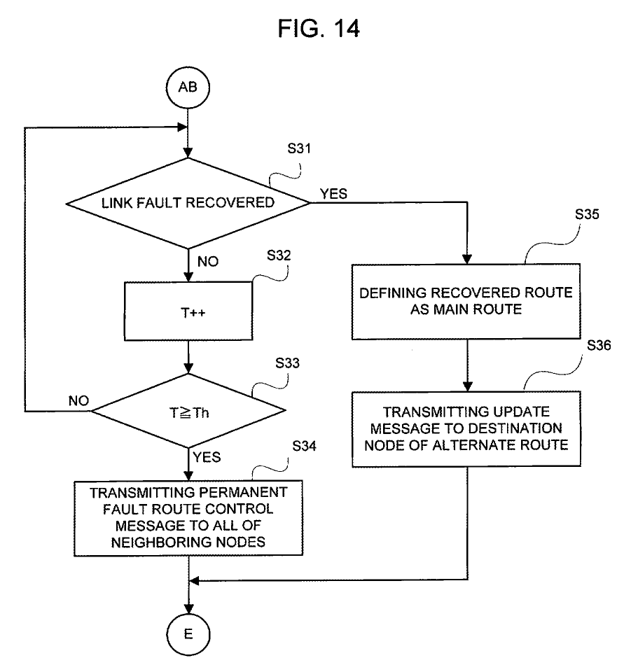

FIG. 14 is a flowchart for explaining an operation that the router apparatus 1B having detected the link fault in the fault detector 131 in accordance with the present invention, and the router apparatus 1B, which is a router apparatus having received the control message in accordance with the technique proposed by the present invention, and determines whether the fault is a temporal fault or a permanent fault with the threshold being held by the router apparatus 1B itself, perform after transmitting the route control message indicative of the temporal fault according to the technique proposed by the present invention. An operation that is performed after transmitting the route control message indicative of the permanent fault is identical to the conventional one, similarly to the operation of FIG. 5. However, the operation that is performed until AB, being a start of this flowchart, is identical to the operation (FIG. 4 or FIG. 6) explained in the example 1.

During the wait, the fault detector 131 determines whether the recovery of the link has been detected, proceeds to a step S35 when it has been detected, and, otherwise, proceeds to a step S32 (step S31).

The fault kind determiner 132 increments T, being a timer value (step S32), determines whether the timer value T exceeds a timer threshold Th, determines that the link fault is not temporal but permanent when it exceeds, and proceeds to a step S34. The fault kind determiner 132 returns to the step S31 when it does not exceed, and waits (step S33).

The transmission kind determiner 141 of the route control message controller 14B decides globally to notify the route control message to the entirety of the network because it has been determined that the link fault is a permanent fault, and the transmission controller 142 transmits the route control message indicative of the permanent fault to all of the neighboring nodes, and thereafter, performs the normal-time operation (step S34).

When the link is recovered, the main route calculation unit 113 defines the recovered route as an optimum route, and registers the packet transfer destination in the use route table 123 (step S35).

The transmission controller 142 of the route control message controller 14B transmits the update message notifying the link recovery to the packet transfer destination of the alternate route employed at the time of the link fault, and thereafter, performs the normal-time operation (step S36).

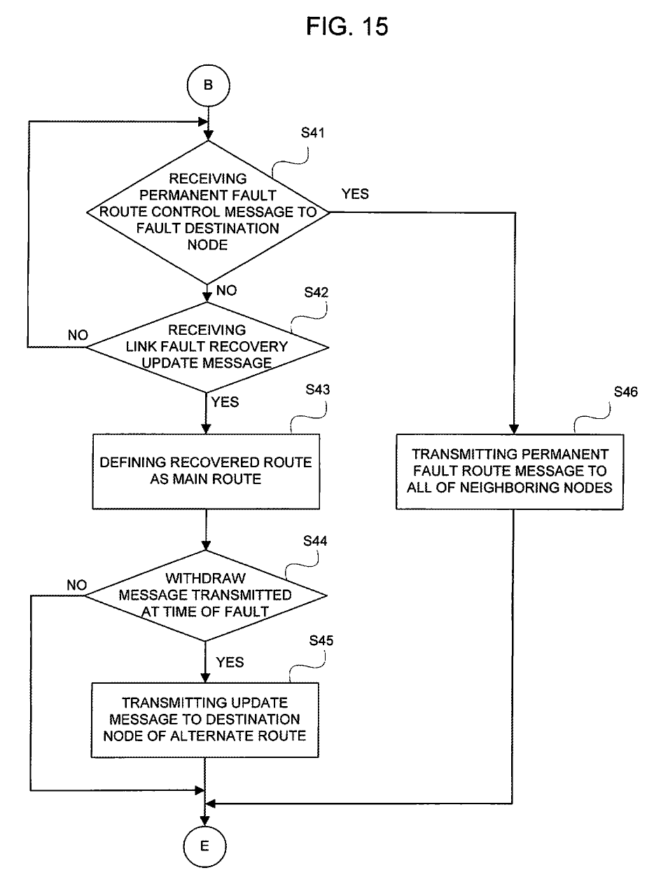

Next, an operation that the router apparatus 1B, which is a router apparatus having received the route control message in accordance with the present invention, and does not determine whether the fault is a temporal fault or a permanent fault from its own information, performs after transmitting the route control message according to the technique proposed by the present invention will be explained by employing a flowchart of FIG. 15. However, the operation that is performed until B, being a start of this flowchart, is identical to the operation (FIG. 6) explained in the example 1.

During the wait, the transmission controller 142 of the route control message controller 14B proceeds to a step S46 when it receives the route control message indicative of the permanent fault associated with the node lying ahead of the link fault, and otherwise, proceeds to a step S42 (step S41).

The transmission controller 142 determines whether the update message notifying the link recovery has been received, proceeds to a step S43 when it has been received, and otherwise, returns to the step S41, and waits (step S42).

The router apparatus 1B having received the update message notifying the link recovery deletes the unusability flag of the route table (RIB) 15, and the main route calculation unit 113 defines the recovered main route as an optimum route, and registers the packet transmission destination in the use route table 123 (step S43).

The transmission controller 142 investigates whether the withdraw message has been transmitted from the alternate route manager 115 at the time of the fault, proceeds to a step S45 when it has been transmitted, and returns to the normal-time operation when the transmission has been stopped (step S44).

The transmission controller 142 transmits the update message notifying the link recovery to the destination to which the withdraw message was transmitted at the time of the link fault, namely, the packet transmission destination of the alternate route, and thereafter, performs the normal-time operation (step S45).

When the transmission controller 142 receives the route control message indicative of the permanent fault, it transmits the route control message indicative of the permanent fault to all of the neighboring nodes (step S46).

The second embodiment differs from the first embodiment in a point that the link fault is determined to be a permanent one when the fault exceeds a certain threshold or level (in this example, when the time that the link fault exceeds the timer threshold is generated), and the link fault detection node globally notifies the route control message to the entirety of the network similarly to the related technique of the present invention.

In such a manner, in this embodiment, an effect that the more stable network can be structured is yielded because it is determined whether the link fault is a temporal one or a permanent one, the alternate route is used when it is a temporal one, and the route information is updated when it is a permanent one.

### Third Embodiment

The third embodiment will be explained.

As described in the first embodiment, it does not matter that a plurality of the alternate routes to the identical destination are calculated, a plurality of the packet transmission destinations exist in the use route table 123 of the packet transfer unit 12. In this case, the transmission of the packet is controlled by the routing policy manager 121. It is assumed that as a method of selecting a plurality of the alternate routes, at least one route is selected, and arbitrary routes of which the number is N or less can be selected according to a route number evaluation function. The route number evaluation function is arbitrarily prepared according to the policy of the AS, or the like. Thus, the number of the alternate routes may be one, and may be N.

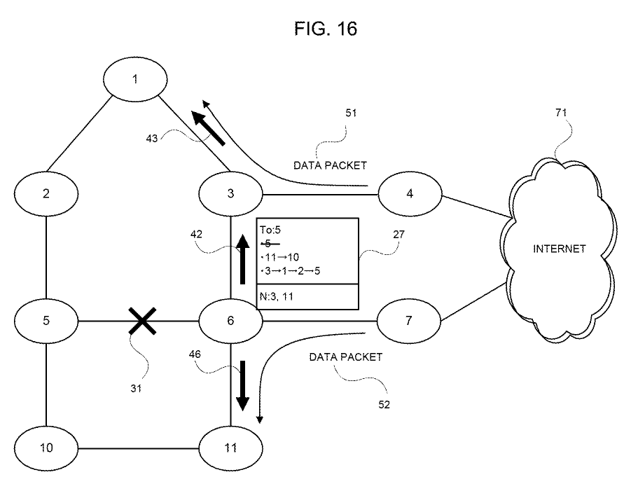

FIG. 16 shows an example of the situation of the network in the case of employing two alternate routes according to the evaluation function of the node 6 at the time of the link fault.

The node 6 having detected the link fault 31 calculates a plurality of the alternate routes based upon its own route number evaluation function. At this time, the alternate routes in a direction of the node 7 are not selected because they do not include the alternate route to the node 5 from a viewpoint of the node 6. In this example, the node 6 defines two routes of 3→1→2→5 and 11→10→5 as an alternate route, respectively, from the route number evaluation function.

In the node route table 27, the node 6 registers two packet transmission destinations in the information of the destination for transmission to the node 5, obeys the policy control of the routing policy manager 121, and decides which destination is employed in order to transmit the packet addressed to the node 5. The node 6 transmits the withdraw messages 42 and 46 in the directions of the two alternate routes, respectively, and the node having received the withdraw message performs the transmission along the alternate routes or stops the transmission according to the evaluation function F( ). Constituting a plurality of the alternate routes in such manner makes it possible to, for example, let a data packet 51 of the node 4 addressed to the node 5 flow in the direction of the node 3 and the node 1, and let a data packet 52 of the node 7 addressed to the node 5 flow in the direction of the node 11 and the node 10.

In accordance with the above-mentioned embodiments, a reduction in the route control messages, which are globally notified whenever the route to the node lying ahead of the link fault is changed, is realized, and the load of transmitting/receiving the route control message upon the nodes constituting the network is reduced at the time of occurrence of the fault of the link or at the time of the recovery.

The reason is that a global spread of the route control messages is prevented because the node having detected the link fault transmits the route control message not to all of the neighboring nodes but to the limited neighboring nodes.

Additionally, while an example in which each unit was configured with hardware was shown in the foregoing embodiments, the main components can be also configured with an information processing apparatus that operates under a program.

The 1st embodiment of the present invention is characterized in that a communication method, wherein a node having received a route control message transmits the route control message to a neighboring node having transmitted said route control message, and at least one neighboring node or more on an alternate route.

Furthermore, the 2nd embodiment of the present invention is characterized in that, in the above-mentioned embodiment, the node having received the route control message associated with a link fault compares a fault route in which the fault has occurred with the selected alternate route by employing an evaluation function F( ) and stops transmission of the route control message when F(alternate route) F(fault route).

Furthermore, the 3rd embodiment of the present invention is characterized in that, in the above-mentioned embodiments, when the node having stopped the transmission of said route control message associated with the link fault receives the route control message associated with link recovery, it stops the transmission of the route control message associated with link recovery.

Furthermore, the 4th embodiment of the present invention is characterized in that, in the above-mentioned embodiments, the node transmits the route control message to the neighboring nodes when no alternate route exists.

Furthermore, the 5th embodiment of the present invention is characterized in that, in the above-mentioned embodiments, the node having detected the link fault transmits the route control message to the neighboring nodes when a value indicative of a degree of the link fault exceeds a predetermined threshold.

Furthermore, the 6th embodiment of the present invention is characterized in that, in the above-mentioned embodiments, said node having detected the link fault transmits the route control message to the neighboring nodes on at least one alternate route or more.

Furthermore, the 7th embodiment of the present invention is characterized in that a communication system that is configure of at least one node or more, wherein said node comprises: a storage unit for storing alternate routes; and a route control message transmission unit for receiving a route control message, selecting at least one alternate route or more from among the alternate routes stored in said storage unit, and transmitting the route control message to the neighboring nodes on the selected alternate route, and the neighboring node having transmitted said route control message.

Furthermore, the 8th embodiment of the present invention is characterized in that, in the above-mentioned embodiment, said route control message transmission unit compares a fault route in which a fault has occurred with the selected alternate route by employing an evaluation function F( ) and stops transmission of the route control message associated with a link fault when F(alternate route)≧F(fault route).

Furthermore, the 9th embodiment of the present invention is characterized in that, in the above-mentioned embodiments, when said route control message transmission unit has stopped the transmission of said route control message associated with the link fault, it stops the transmission of the received route control message associated with link recovery.

Furthermore, the 10th embodiment of the present invention is characterized in that, in the above-mentioned embodiments, said route control message transmission unit transmits the route control message to the neighboring nodes when no alternate route being selected exists.

Furthermore, the 11th embodiment of the present invention is characterized in that, in the above-mentioned embodiments, said node comprises a link fault detector for detecting the link fault, and a comparer for comparing a value indicative of a degree of said detected link fault with a predetermined threshold; and said route control message transmission unit transmits the route control message to the neighboring nodes when said value indicative of a degree of the detected link fault exceeds said predetermined threshold.

Furthermore, the 12th embodiment of the present invention is characterized in that, in the above-mentioned embodiments, said route control message transmission unit selects at least one alternate route or more from among the alternate routes stored in said storage unit when its own node detects the link fault, and transmits the route control message to the neighboring nodes on the selected alternate route.

Furthermore, the 13th embodiment of the present invention is characterized in that a node, comprising: a storage unit for storing alternate routes; and a route control message transmission unit for receiving a route control message, selecting at least one alternate route or more from among the alternate routes stored in said storage unit, and transmitting the route control message to neighboring nodes on the selected alternate route, and the neighboring node having transmitted said route control message.

Furthermore, the 14th embodiment of the present invention is characterized in that, in the above-mentioned embodiment, said route control message transmission unit compares a fault route in which a fault has occurred with the selected alternate route by employing an evaluation function F( ), and stops transmission of the route control message associated with a link fault when F(alternate route) F(fault route).

Furthermore, the 15th embodiment of the present invention is characterized in that, in the above-mentioned embodiments, when said route control message transmission unit has stopped the transmission of said route control message associated with the link fault, it stops the transmission of the received route control message associated with link recovery.

Furthermore, the 16th embodiment of the present invention is characterized in that, in the above-mentioned embodiments, said route control message transmission unit transmits the route control message to the neighboring nodes when no alternate route being selected exists.

Furthermore, the 17th embodiment of the present invention is characterized in that, in the above-mentioned embodiments, the node comprising a link fault detector for detecting the link fault, and a comparer for comparing a value indicative of a degree of said detected link fault with a predetermined threshold, wherein said route control message transmission unit transmits the route control message to the neighboring nodes when said value indicative of a degree of the detected link fault exceeds said predetermined threshold.

Furthermore, the 18th embodiment of the present invention is characterized in that, in the above-mentioned embodiments, said route control message transmission unit selects at least one alternate route or more from among the alternate routes stored in said storage unit when its own node detects the link fault, and transmits the route control message to the neighboring nodes on the selected alternate route.

Furthermore, the 19th embodiment of the present invention is characterized in that a program for causing an information processing apparatus to execute: an alternate route selection process of, when receiving a route control message, selecting at least one alternate route or more from among alternate routes stored in a storage unit; and a route control message transmission process of transmitting the route control message to neighboring nodes on the selected alternate route, and the neighboring node having transmitted said route control message.

Furthermore, the 20th embodiment of the present invention is characterized in that, in the above-mentioned embodiment, said route control message transmission process compares a fault route in which a fault has occurred with the selected alternate route by employing an evaluation function F( ) and stops transmission of the route control message associated with a link fault when F(alternate route)≧F(fault route).

Furthermore, the 21st embodiment of the present invention is characterized in that, in the above-mentioned embodiments, when said route control message transmission process has stopped the transmission of said route control message associated with the link fault, it stops the transmission of the received route control message associated with link recovery.

Furthermore, the 22nd embodiment of the present invention is characterized in that, in the above-mentioned embodiments, said route control message transmission process transmits the route control message to the neighboring nodes when no alternate route being selected exists.

Furthermore, the 23rd embodiment of the present invention is characterized in that, in the above-mentioned embodiments, a program causing the information processing apparatus to execute: a link fault detection process of detecting the link fault; a comparison process of comparing a value indicative of a degree of said detected link fault with a predetermined threshold; and a process of transmitting the route control message to the neighboring nodes when said value indicative of a degree of the detected link fault exceeds said predetermined threshold.

Furthermore, the 24th embodiment of the present invention is characterized in that, in the above-mentioned embodiment, said route control message transmission process selects at least one alternate route or more from among the alternate routes stored in said storage unit when its own node detects the link fault, and transmits the route control message to the neighboring nodes on the selected alternate route.

Furthermore, the 25th embodiment of the present invention is characterized in that a communication method, wherein a node having received a route control message transmits the route control message to neighboring nodes on at least one alternate route or more.

Furthermore, the 26th embodiment of the present invention is characterized in that a node, comprising: a storage unit for storing alternate routes; and a route control message transmission unit for, when receiving a route control message, selecting at least one alternate route or more from among the alternate routes stored in said storage unit, and transmitting the route control message to neighboring nodes on the selected alternate route.

Furthermore, the 27th embodiment of the present invention is characterized in that a communication method, wherein a node having received a cancel route information transmits arrivable route information only to a neighboring node having transmitted the cancel route information.

Furthermore, the 28th embodiment of the present invention is characterized in that a node, comprising a means for, when receiving a cancel route information, transmitting arrivable route information only to a neighboring node having transmitted the cancel route information.

Above, although the present invention has been particularly described with reference to the preferred embodiments and examples thereof, it should be readily apparent to those of ordinary skill in the art that the present invention is not always limited to the above-mentioned embodiment and examples, and changes and modifications in the form and details may be made without departing from the sprit and scope of the invention.

This application is based upon and claims the benefit of priority from Japanese patent application No. 2007-305835, filed on Nov. 27, 2007, the disclosure of which is incorporated herein in its entirety by reference.

1-28. (canceled)

29. A communication method, wherein a node having received a route control message transmits the route control message to a neighboring node having transmitted said route control message, and at least one neighboring node or more on an alternate route.

30. A communication method according to claim 29, wherein the node having received the route control message associated with a link fault compares a fault route in which the fault has occurred with the selected alternate route by employing an evaluation function F( ), and stops transmission of the route control message when F(alternate route)≧F(fault route).

31. A communication method according to claim 30, wherein when the node having stopped the transmission of said route control message associated with the link fault receives the route control message associated with link recovery, it stops the transmission of the route control message associated with link recovery.

32. A communication method according to claim 29, wherein the node transmits the route control message to the neighboring nodes when no alternate route exists.

33. A communication method according to claim 29, wherein the node having detected the link fault transmits the route control message to the neighboring nodes when a value indicative of a degree of the link fault exceeds a predetermined threshold.

34. A communication method according to claim 29, wherein said node having detected the link fault transmits the route control message to the neighboring nodes on at least one alternate route or more.

35. A communication system that is configure of at least one node or more, wherein said node comprises:
a storage unit that stores alternate routes; and
a route control message transmission unit that receives a route control message, selects at least one alternate route or more from among the alternate routes stored in said storage unit, and transmits the route control message to the neighboring nodes on the selected alternate route, and the neighboring node having transmitted said route control message.

36. A communication system according to claim 35, wherein said route control message transmission unit compares a fault route in which a fault has occurred with the selected alternate route by employing an evaluation function F( ), and stops transmission of the route control message associated with a link fault when F(alternate route)≧F(fault route).

37. A communication system according to claim 36, wherein when said route control message transmission unit has stopped the transmission of said route control message associated with the link fault, it stops the transmission of the received route control message associated with link recovery.

38. A communication system according to claim 35, wherein said route control message transmission unit transmits the route control message to the neighboring nodes when no alternate route being selected exists.

39. A communication system according to claim 37:
wherein said node comprises a link fault detector for detecting the link fault, and a comparer for comparing a value indicative of a degree of said detected link fault with a predetermined threshold; and
wherein said route control message transmission unit transmits the route control message to the neighboring nodes when said value indicative of a degree of the detected link fault exceeds said predetermined threshold.

40. A communication system according to claim 35, wherein said route control message transmission unit selects at least one alternate route or more from among the alternate routes stored in said storage unit when its own node detects the link fault, and transmits the route control message to the neighboring nodes on the selected alternate route.

41. A node, comprising:
a storage unit that stores alternate routes; and
a route control message transmission unit that receives a route control message, selects at least one alternate route or more from among the alternate routes stored in said storage unit, and transmits the route control message to neighboring nodes on the selected alternate route, and the neighboring node having transmitted said route control message.

42. A node according to claim 41, wherein said route control message transmission unit compares a fault route in which a fault has occurred with the selected alternate route by employing an evaluation function F( ), and stops transmission of the route control message associated with a link fault when F(alternate route)≧F(fault route).

43. A node according to claim 42, wherein when said route control message transmission unit has stopped the transmission of said route control message associated with the link fault, it stops the transmission of the received route control message associated with link recovery.

44. A node according to claim 41, wherein said route control message transmission unit transmits the route control message to the neighboring nodes when no alternate route being selected exists.

45. A node according to claim 41, comprising a link fault detector for detecting the link fault, and a comparer for comparing a value indicative of a degree of said detected link fault with a predetermined threshold, wherein said route control message transmission unit transmits the route control message to the neighboring nodes when said value indicative of a degree of the detected link fault exceeds said predetermined threshold.

46. A node according to claim 41, wherein said route control message transmission unit selects at least one alternate route or more from among the alternate routes stored in said storage unit when its own node detects the link fault, and transmits the route control message to the neighboring nodes on the selected alternate route.

47. A computer readable storage medium storing computer instructions for causing a computer executing the instructions, said instructions causing said computer to implement a method comprising:
an alternate route selection process of, when receiving a route control message, selecting at least one alternate route or more from among alternate routes stored in a storage unit; and
a route control message transmission process of transmitting the route control message to neighboring nodes on the selected alternate route, and the neighboring node having transmitted said route control message.

48. A communication method, wherein a node having received a cancel route information transmits arrivable route information to a neighboring node having transmitted the cancel route information.

49. A node, comprising a means for, when receiving a cancel route information, transmitting arrivable route information to a neighboring node having transmitted the cancel route information.
